(19) United States
(12) Patent Application Publication
(10) Pub. No.: US 2026/0042167 A1
(43) Pub. Date: Feb. 12, 2026

(54) PRESSURIZING ASSEMBLY, DEVICE AND METHOD FOR DIFFUSION WELDING OF CURVED-SURFACE WORKPIECE

(71) Applicant: Nuclear Power Institute of China, Chengdu (CN)

(72) Inventors: Jia TANG, Chengdu (CN); Yanping HUANG, Chengdu (CN); Ruilong LIU, Chengdu (CN); Minyun LIU, Chengdu (CN); Chuan JIA, Chengdu (CN)

(73) Assignee: Nuclear Power Institute of China, Chengdu (CN)

(21) Appl. No.: 19/364,328

(22) Filed: Oct. 21, 2025

Related U.S. Application Data
(63) Continuation of application No. PCT/CN2024/124140, filed on Oct. 11, 2024.

(30) Foreign Application Priority Data
Jan. 15, 2024 (CN) 202410051062.9

(51) Int. Cl. B23K 20/02; B23K 37/02

(52) U.S. Cl. CPC B23K 20/023; B23K 37/0247

(57) ABSTRACT

A pressurizing assembly includes: a dot-matrix pressurizing member including a driving base and a plurality of pressurizing rods, the driving base being provided with a plurality of mounting positions arranged in a dot-matrix pattern, with each pressurizing rod mounted at its respective mounting position and all the pressurizing rods being parallel to each other, and the driving base being configured to independently drive the plurality of pressurizing rods so as to apply localized and independent pressure to the curved-surface workpiece; and an induction heating element disposed adjacent to a free end of each pressurizing rod to heat respective surface regions of the curved-surface workpiece.

### CROSS-REFERENCE TO RELATED APPLICATIONS

The present application is a continuation application of International Application No. PCT/CN2024/124140, filed on Oct. 11, 2024, which claims priority to Chinese Patent Application No. 202410051062.9, filed with the China National Intellectual Property Administration on Jan. 15, 2024. All of the aforementioned applications are incorporated herein by reference in their entireties.

### TECHNICAL FIELD

The present application relates to the technical field of diffusion welding forming, and in particular, to a pressurizing assembly, a device, and a method for diffusion welding of a curved-surface workpiece.

### BACKGROUND

Diffusion welding forming is a solid-state joining technique in which two workpieces to be welded are tightly pressed together in a vacuum or inert gas environment and then heated, causing plastic deformation at their surfaces to achieve intimate contact. Subsequent heating and holding allow atoms on both sides of the contact surfaces to diffuse into each other, thereby forming a metallurgical bond. This method enables full-area bonding at the interface, which is crucial for achieving high-strength internal connections in plate-like workpieces. Moreover, since there is no melting and solidification phase transformation during welding, the base material retains its original properties with no significant degradation, and the strength of the welded joint is close to, or even matches, that of the base material itself. Diffusion welding is suitable for joining most metals, as well as some ceramics, glass, silicon, and other non-metallic materials. It also supports dissimilar material combinations, including metal-to-metal and even metal-to-nonmetal joints.

At present, conventional diffusion welding equipment is mainly designed for flat workpieces. These systems typically apply pressure to the entire welding platen through a limited number of loading points, which can only impose even stress across the welded components. Heating is generally performed using sidewall heating assemblies, which are ineffective for adequately heating the top and bottom surfaces of the workpieces. As a result, existing diffusion welding equipment and methods cannot meet the demands of pressure zoning adjustment under non-even temperature field conditions, and are therefore unsuitable for curved or complex-shaped workpieces. There is a clear need for a solution that enables adjustable pressure locally, specifically tailored for diffusion welding of various types of curved-surface workpieces.

### SUMMARY

The main purpose of the present application is to provide a pressurizing assembly, a device and a method for diffusion welding of curved-surface workpieces, so as to solve the problem of poor welding performance on irregular curved-surfaces with existing diffusion welding equipment.

In order to achieve the above purpose, the present application provides the following technical solutions. A pressurizing assembly for diffusion welding of a curved-surface workpiece is provided. The pressurizing assembly includes: a dot-matrix pressurizing member including a driving base and a plurality of pressurizing rods, the driving base being provided with a plurality of mounting positions arranged in a dot-matrix pattern, with each pressurizing rod mounted at its respective mounting position and all the pressurizing rods being parallel to each other, and the driving base being configured to independently drive the plurality of pressurizing rods so as to apply localized and independent pressure to the curved-surface workpiece.

In an embodiment, the pressurizing assembly further includes an induction heating element disposed adjacent to a free end of each pressurizing rod to heat respective surface regions of the curved-surface workpiece.

In an embodiment, the pressurizing assembly further includes a curved-surface contact member, the curved-surface contact member includes a platen base fixedly connected to the free end of each pressurizing rod, and a multi-level movable platen assembly disposed at the end of each platen base opposite the pressurizing rod, the movable platen assembly including a plurality of stacked movable platens, each platen base is movably connected to the adjacent movable platen and adjacent movable platens are movably connected to one another via electromagnetic attraction and cooperating socket joints.

In an embodiment, each socket joint is a cylindrical concave cavity formed on the side of the platen base opposite the pressurizing rod and on the side of each movable platen facing the next lower-level movable platen, and each movable platen is engaged with a respective cylindrical concave cavity and configured to move therein under external force, the number of movable platens increases progressively in the direction from the platen base to the curved-surface workpiece.

In an embodiment, the socket joint is a spherical concave cavity, positioned on a side of the platen base that is remote from the pressurizing rod and on a side of the movable platen that is adjacent to a next movable platen, the movable platen is engaged with the spherical concave cavity and moves within the spherical concave cavity under external force, the number of movable platens increases progressively from the platen base toward the curved-surface workpiece.

In an embodiment, a solder mask plate is provided on the movable platen of the movable platen assembly that contacts the curved-surface workpiece.

In an embodiment, the driving base is configured to drive each pressurizing rod by means of hydraulic pressure, pneumatic pressure, or mechanical actuation.

In an embodiment, an array profile of the mounting positions is a regular polygon.

In another aspect, the present application further provides a device for diffusion welding of a curved-surface workpiece. The device includes a pressurizing system whose output end is configured to connect the pressurizing assembly to drive the pressurizing assembly to apply pressure to a workpiece to be welded.

According to still another aspect, the present application further provides a method for diffusion welding of a curved-surface workpiece, where the method is applied to a device for diffusion welding of a curved-surface workpiece. The device includes a pressurizing system and the pressurizing assembly, and an output of the pressurizing system is connected to the pressurizing assembly. The method includes: determining whether a maximum thermal stress value ΔSₘₐₓ of a workpiece to be welded under even heating conditions exceeds a preset allowable limit ΔSₗᵢₘ; performing heating, if ΔSₘₐₓ exceeds ΔSₗᵢₘ, according to a preset local heating temperature, and using whether the maximum thermal stress value ΔSₘₐₓ of the workpiece to be welded under local heating conditions exceeds the preset allowable limit ΔSₗᵢₘ as an iteration condition to determine upper and lower wall surface local heating temperatures and a temperature distribution field of the workpiece to be welded; determining, based on the determined upper and lower wall surface local heating temperatures and the first temperature distribution field of the workpiece to be welded, the stress to be applied to the workpiece to be welded locally; selecting a matching dot-matrix pressurizing member according to the determined stress and a surface curvature of the workpiece to be welded; and performing localized pressurizing and heating on the workpiece to be welded using the dot-matrix pressurizing member and the induction heating member of the pressurizing assembly to perform diffusion welding.

In an embodiment, in the determining whether a maximum thermal stress value ΔSₘₐₓ of a workpiece to be welded under uneven heating conditions exceeds a preset allowable limit ΔSₗᵢₘ, the even heating conditions includes: evenly heating the side wall surfaces of the workpiece to be welded and evenly heating the upper and lower wall surfaces of the workpiece to be welded.

In an embodiment, in the determining, based on the determined upper and lower wall surface local heating temperatures and the first temperature distribution field of the workpiece to be welded, the stress to be applied to the workpiece to be welded locally, the stress to be applied to the workpiece to be welded locally is determined from

$${Q}_{local} = {C}_{0} exp ( - E / {RT}_{local} ) {σ}_{local}^{n} ,$$

where Q_{local} represents a local diffusion welding strength of the workpiece, T_{local} represents a local temperature of the workpiece, σ_{local} represents a local stress of the workpiece, C₀ is a normalization coefficient and a constant, n is a normalization exponent, E represents volume diffusion activation energy and is a material-related constant, and R is the gas constant.

The pressurizing assembly for diffusion welding of a curved-surface workpiece of the present application is used for pressurizing the curved-surface workpiece after being connected to a pressurizing system, and includes a dot-matrix pressurizing member and an induction heating member, the dot-matrix pressurizing member includes a driving base and a plurality of pressurizing rods, the driving base is provided with a plurality of mounting positions distributed in a dot-matrix, the pressurizing rods are mounted in respective mounting positions, and all the pressurizing rods are parallel to each other. The driving base independently drives each pressurizing rod mounted at the respective mounting positions, thereby enabling localized and independent pressurization of the curved-surface workpiece. In the present application, the pressurizing assembly includes a dot-matrix pressurizing unit formed by arranging multiple mounting positions in a dot-matrix pattern on the same surface of the driving base, with each mounting position fitted with a pressurizing rod. The dot-matrix pressurizing unit is controlled by a pressurization system, and the pressurization system independently controls each pressurizing rod via the driving base without mutual interference. This configuration allows the applied stress across different regions of the pressurizing assembly to be adjusted based on the actual contour of the curved-surface workpiece during diffusion welding. Additionally, induction heating elements are provided near the free ends of the pressurizing rods to achieve localized heating of the curved-surface of the workpiece, thereby accommodating the different heating temperatures required by different areas of an irregular curved-surface workpiece. In summary, the pressurizing assembly disclosed herein addresses the problem in conventional diffusion welding where flat, even-pressure components cannot be used for welding curved-surface workpieces, and effectively enables diffusion welding of such curved curved-surface workpieces.

### BRIEF DESCRIPTION OF THE DRAWINGS

FIG. 1 is a simplified structural diagram of a diffusion welding device in the related art.

FIG. 2 is a schematic diagram of a principle of pressure welding performed by a diffusion welding device in the related art.

FIG. 3 is a schematic diagram of a temperature distribution formed by heating a side wall surface of a diffusion welding device on a workpiece to be welded in the related art.

FIG. 4 is a schematic structural diagram of a pressurizing assembly according to an embodiment of the present application.

FIG. 5 is a simplified enlarged structural diagram of the pressurizing assembly in the embodiment of FIG. 4.

FIG. 6 is a schematic structural diagram of a curved-surface contact member according to an embodiment of the present application.

FIG. 7 is a schematic structural diagram of a curved-surface contact member according to another embodiment of the present application.

FIG. 8 is a schematic diagram of steps of a method for performing diffusion welding on curved-surfaces by a pressurizing assembly according to the present application.

FIG. 9 is a schematic diagram of steps of a method for performing diffusion welding on curved-surfaces by a pressurizing assembly according to the present application.

Implementations, functional features, and advantages of the present disclosure will be further described with reference to the accompanying drawings in combination with the embodiments.

### DETAILED DESCRIPTION OF THE EMBODIMENTS

The following clearly and completely describes the technical solutions in the embodiments of the present application with reference to the accompanying drawings in the embodiments of the present application. It is evident that the described embodiments are merely part of the embodiments of the present application, and not all of them. All other embodiments obtained by a person of ordinary skill in the art based on the embodiments of the present application without creative efforts shall fall within the protection scope of the present application.

The terms “first”, “second” and “third” in the present application are only used for descriptive purposes, and cannot be understood as indicating or implying relative importance or implicitly indicating the number of indicated technical features. Therefore, the features defined with “first”, “second” and “third” may explicitly or implicitly include at least one of the features. In the description of the present application, “a plurality of” means at least two, for example, two, three, and the like, unless specified otherwise. All directional indications (such as upper, lower, left, right, front, and back) in the embodiments of the present application. The relative position relation, the movement condition and the like between the parts under a certain specific posture (as shown in the drawings) are only used for explaining the relative position relation, the movement condition and the like between the parts under a certain specific posture (as shown in the drawings), and if the specific posture changes, the directional indication also changes accordingly. In addition, the terms “include” and “have” and any variations thereof are intended to cover non-exclusive inclusion. For example, a process, method, system, product, or device that includes a series of steps or units is not limited to the listed steps or units, but optionally further includes steps or units that are not listed, or optionally further include other steps or units inherent to the process, method, product, or device.

As used herein, the term “embodiment” means that a particular feature, structure, or characteristic described in connection with the embodiment may be included in at least one embodiment of the present application. The appearances of such phrases in various places throughout the specification are not necessarily all referring to the same embodiment, nor are separate or alternative embodiments mutually exclusive of other embodiments. It is understood by those skilled in the art, both explicitly and implicitly, that the embodiments described herein can be combined with other embodiments.

Diffusion welding forming is a type of solid-state joining process. During welding, two workpieces to be joined are tightly pressed together and heated in a vacuum or protective gas environment. The microscopic protrusions on the surfaces of the workpieces undergo plastic deformation under pressure, resulting in intimate contact. Subsequent heating and holding allow atomic diffusion across the contacting surfaces, thereby forming a metallurgical bond. Diffusion welding enables bonding across the entire interface, which is particularly important for achieving high-strength internal connections between plate-type workpieces. In addition, since no melting and solidification phase transition occurs during the welding process, the base material maintains its original properties, and the strength of the welded joint can approach or even match that of the base material. The diffusion welding is suitable for joining of most metals, some ceramics, glass, silicon materials, and even dissimilar materials such as metal-to-metal and metal-to-nonmetal combinations.

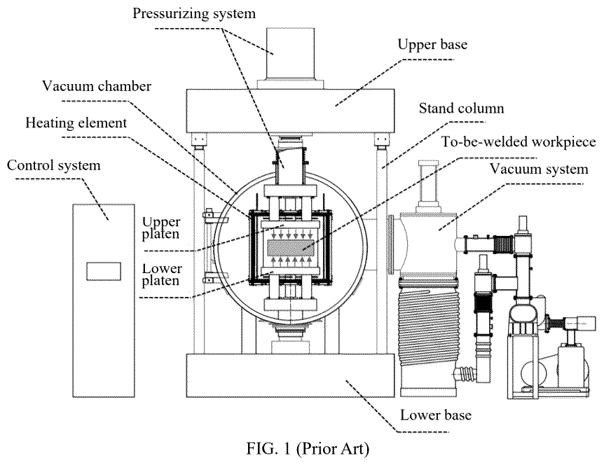

As shown in FIG. 1, an existing diffusion welding device typically includes a pressurizing system, a vacuum system, a heating element, and a control system. The heating element generally includes electric heating components arranged along the inner wall of the welding chamber, and heats the workpieces through thermal radiation during the bonding process. The pressurizing system includes a hydraulic boosting unit, hydraulic cylinders, connecting rods, and clamping plates. During the bonding process, the hydraulic system drives the connecting rods to displace, thereby applying pressure to the workpieces through upper and lower pressing plates. This ensures intimate contact between the bonding surfaces of the workpieces, and enables atomic diffusion across the bonding interface under combined thermal and pressure loads, thereby forming a strong metallurgical joint. The vacuum system is configured to extract gases from the bonding chamber to prevent oxidation of the workpieces at high temperatures. The control system is configured to regulate key process parameters such as temperature, pressure, vacuum level, and holding time in accordance with a pre-programmed bonding cycle.

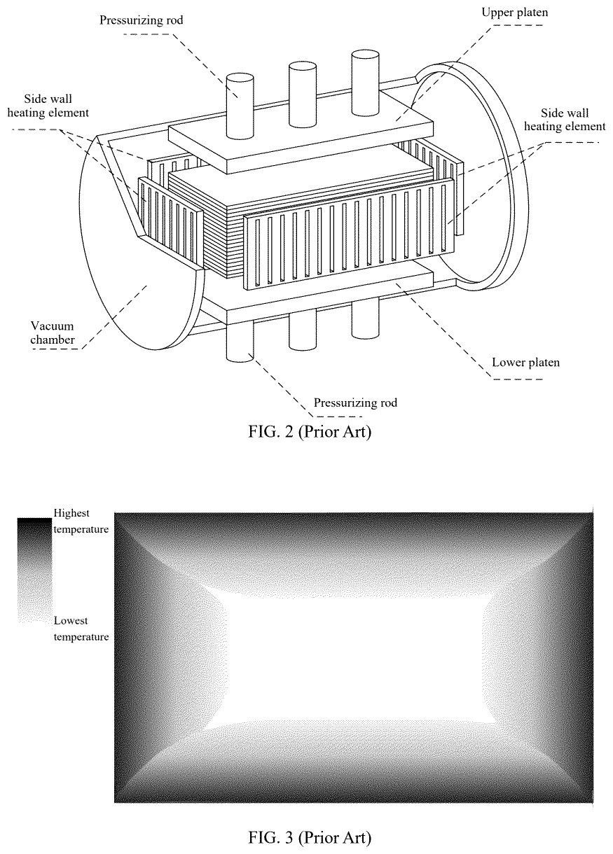

As shown in FIG. 2, the conventional diffusion welding device is only suitable for diffusion welding forming of a planar workpiece, and a small number of pressure applying points act on a whole solder mask plate, and the method can only apply uneven and consistent stress to the welded workpiece. On the other hand, the workpiece to be welded is heated through the side wall surface heating assembly, so that the upper surface and the lower surface of the workpiece cannot be effectively heated. Therefore, the current diffusion welding apparatus and method cannot meet the requirement of pressure applying pressure local adjustment under a non-even temperature field condition, and cannot be applied to a curved-surface workpiece.

In the side wall surface heating mode adopted by the conventional diffusion welding equipment, the temperature distribution of the cross section of the workpiece is shown in FIG. 3, during diffusion welding, the workpiece to be welded is heated by the heating element on the side wall of the temperature area in a thermal radiation mode, heat is transmitted to the interior of the workpiece from the surface of the workpiece in a heat conduction mode, due to the fact that the workpiece material has thermal resistance, the temperature distribution of the workpiece to be welded cannot be even and consistent, the surface temperature of the workpiece material is the highest, the central area is the lowest, the diffusion welding bonding strength is jointly determined by factors such as temperature and stress value, and the model shown in the formula (1) can be constructed by integrating the influence factors:

$${Q}_{local} = f ( {T}_{local} , {σ}_{local} , {t}_{s} , M , {F}_{local} ) \qquad ( 1 )$$

where Q_{local} represents the local diffusion welding strength of the workpiece, T_{local} represents the local temperature of the workpiece, σ_{local} represents the local uneven value of the workpiece, tₛ represents the heat preservation time of the workpiece, M represents a parameter related to the type of the material, and E represents the roughness of the local position of the surface of the material. For each position of the same workpiece, tₛ, M, F_{local} can ignore the difference and fit them into a constant term, then for a certain workpiece, the local diffusion welding strength of each position of the workpiece has the following relationship:

$${Q}_{local} = f ( {T}_{local} , {σ}_{local} ) \qquad ( 2 )$$

With regard to the effect of the diffusion welding temperature, there are the following models:

$$D = {D}_{0} exp ( - E / {RT}_{local} ) \qquad ( 3 )$$

D represents the diffusion coefficient, the larger the value indicates the stronger the diffusion of the metal atom, the better the diffusion welding strength, and therefore can represent the diffusion welding strength. D₀ is a constant coefficient, E represents a volume diffusion activation energy, which is a constant related to a material type, and R represents a gas constant.

Regarding the influence of the diffusion welding stress, there are the following models according to the law of the power exponent of the uneven-strain in the diffusion welding creep process:

$$ε = {σ}_{local} / E + {A}_{0} {σ}_{local}^{m} \qquad ( 4 )$$

ε represents the strain value in the diffusion welding process, and the larger the value indicates the larger the diffusion welding strength, the larger the diffusion welding strength, and can be used to represent the diffusion welding strength. E represents the Young modulus of the material, A₀ is a constant coefficient, and m is a constant index.

Therefore, equation (2) can be written as follows:

$${Q}_{local} = {C}_{0} exp ( - E / {RT}_{local} ) {σ}_{local}^{n} \qquad ( 5 )$$

C₀ represents a normalization coefficient, and is a constant, and n is a normalization index. It can be seen from formula (5) that the strength of T_{local} and σ_{local} and the strength of the diffusion welding joint are in positive correlation during diffusion welding, and both the welding temperature and the pressing stress can be increased to obtain a better welding effect.

It can be seen from the model of formula (5) that for the problem of uneven temperature distribution of the workpiece, cooperative control needs to be performed by means of pressure load local adjustment, a relatively minimum pressure load should be applied to the peripheral area of the workpiece to be welded, a relatively maximum pressure load is applied to the central area of the workpiece to be welded, and other areas should apply a corresponding pressure load from formula (5) according to the change of the temperature.

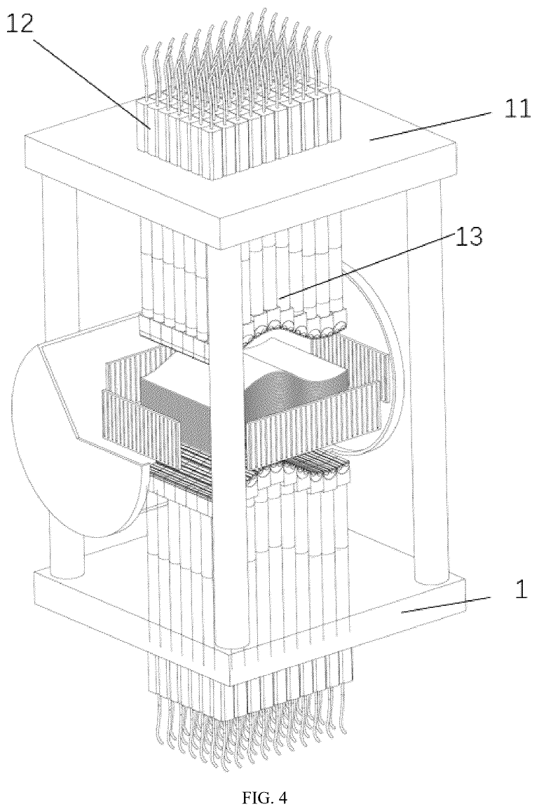

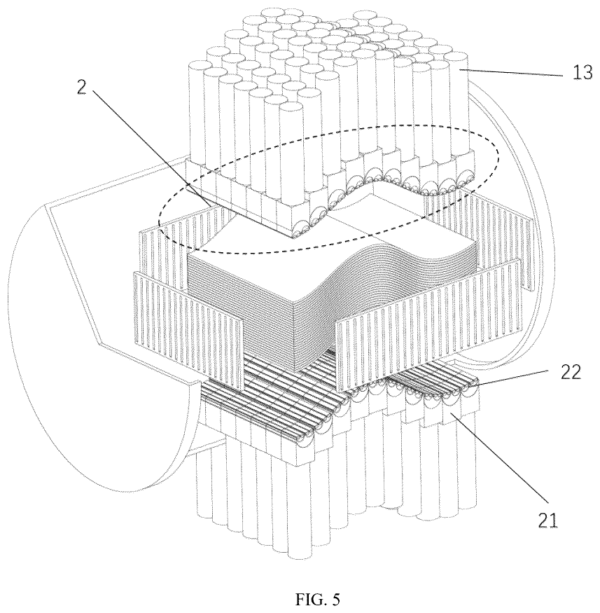

In view of the above-mentioned problem that the existing diffusion welding equipment cannot be applied to a curved-surface workpiece, the present application provides a pressurizing assembly for independently controlling pressure applying by applying pressure to the dot matrix by means of dot matrix pressurizing, so as to cope with the welding pressure requirement of the workpiece on the curved-surface and the irregular surface. As shown in FIG. 4 and FIG. 5 show an embodiment of a pressurizing assembly for diffusion welding of a curved-surface workpiece. The pressurizing assembly is configured to connect to a pressurizing system to pressurize the curved-surface workpiece, and the pressurizing assembly includes a dot-matrix pressurizing member 1.

The dot-matrix pressurizing member 1 includes a driving base 11 and a plurality of pressurizing rods 13, the driving base 11 is provided with a plurality of mounting positions 12 distributed in a dot matrix pattern, one pressurizing rod 13 is mounted at its respective mounting position 12. All the pressurizing rods 13 are parallel to each other. The driving base 11 independently drives the pressurizing rods 13, so as to apply localized and independent pressure to the curved-surface workpiece.

In an embodiment, the driving mode of the driving base 11 may be hydraulic driving, pneumatic driving, and mechanical propulsion, and in terms of driving power, since the pressurizing assembly is connected to the pressurizing system, the dot-matrix pressurizing member 1 may obtain the power source through the current voltage of the pressurizing system. The “dot-matrix” pattern refers to a distribution structure formed in an array manner in a specific direction, for example, in this embodiment, a certain mounting position 12 is used as a “starting point”, and a plurality of same mounting positions 12 are respectively arranged at the same interval in the transverse direction and the longitudinal direction to form a dot matrix plane with a length and a width. The pressurizing rod 13 may include any rod member capable of being extended or shortened in the axial direction, the pressurizing rod 13 is mounted at the mounting position 12 of the driving base 11, and correspondingly, according to the dot-matrix distribution structure of the mounting position 12, the ends of all the pressurizing rods 13 also form a dot-matrix surface, and different curved-surface structures can be adapted by changing the length of each pressurizing rod 13 to apply and adjust the stress acting on each region on the curved-surface workpiece.

In an embodiment, the dot matrix distribution contour of the installation bit 12 is a regular polygon.

The formation of the regular polygon is described in the foregoing implementations by way of example, and details are not described herein again. The regular polygon may be selected according to needs, and the side length of the regular polygon (that is, adjusting by setting the number of the mounting positions 12 in the same direction) and the number of sides of the regular polygon enables the dot-matrix pressurizing member 1 to have better adaptability to curved-surface workpieces of different morphological structures, that is, as long as the area of the dot-matrix surface is greater than the minimum surrounding area of the curved-surface workpiece (the minimum surrounding area may be expressed in a circular or regular polygon form), the dot-matrix pressurizing member 1 may be subjected to pressure welding, thereby improving the utilization rate of each pressurizing rod 13 in the dot-matrix pressurizing member 1.

In an embodiment, as shown in FIG. 4 or FIG. 5, the curved-surface workpiece is a workpiece to be welded with a wavy longitudinal cross section, and the welding requirement retains a longitudinal cross-sectional form, then the analog form data is input through the pressurizing system, and the control signal is output to the dot-matrix pressurizing member 1 according to the setting program, so that each pressurizing rod 13 in the dot-matrix pressurizing member 1 is elongated or shortened according to the instruction data in the signal, a wavy shape consistent with the longitudinal section of the workpiece to be welded is formed, and a proper stress is applied to each area of the workpiece to be welded.

It should be noted that the specific parameters of the dot-matrix plane formed by the dot-matrix pressurizing member 1 are not given in the present demonstration example, and are intended to include all the dot-matrix plane parameter setting ranges capable of achieving the curved-surface pressurizing effect. It can be understood that the specific parameters of the dot-matrix surface formed by the dot-matrix pressurizing member 1 at least include the spacing between the adjacent mounting positions 12, the number of the mounting positions 12, the degree of density change (which may be represented by the ratio of the number of the outermost mounting positions 12 to the number of the innermost mounting positions 12), the straight (half) diameter of the pressurizing rod 13, the number of the pressurizing rods 13, the telescopic range, and the like. When the number of the mounting positions 12 is not limited, the larger the distance between the adjacent mounting positions 12 is, the more the mounting positions 12 are, the better the pressurizing effect is, that is, adjusting the spacing parameters and other related parameters of the adjacent mounting positions 12 may improve the overall acting precision of the pressurizing assembly to different degrees, which is more beneficial to the implementation of the pressurizing effect of the pressurizing assembly of the present application, but it is a further improvement of the implementation effect of the foregoing embodiments, and the technical feature improvement proposed on this basis should be included in the scope of protection claimed by the present disclosure.

With reference to the above technical solution and explanation, the pressurizing assembly of the present application is provided with a plurality of mounting positions 12 distributed in a dot matrix on the same surface, and a pressurizing rod 13 is mounted on each mounting position 12 to form a dot matrix pressurizing member 1. The dot matrix pressurizing member 1 is controlled by the pressurizing system, and the pressurizing system adjusts the stress of each region of the pressurizing assembly according to the actual contour of the curved-surface workpiece by driving the base 11 to perform pressure welding on the curved-surface workpiece, so that the stress is effectively applied according to the curvature change of the curved-surface workpiece compared with the existing planar equivalent pressurizing assembly.

In an embodiment, on the basis of the foregoing embodiment, the pressurizing assembly further includes a curved-surface contact member 2, the curved-surface contact member 2 includes a platen base 21 fixedly connected to a free end of each pressurizing rod 13, one end of each platen base 21 away from the pressurizing rod 13 is provided with a multi-stage movable platen assembly 22, the movable platen assembly 22 includes a plurality of movable platens arranged in a layer, and each platen base 21 is movably connected with an adjacent movable platen and each movable platen through electromagnetic adsorption and mutually matched joint sockets.

In an embodiment, the end of each pressurizing rod 13 is connected with the platen base 21 and the movable platen assembly 22 in sequence from the near end to the far end, and the end of the pressurizing rod 13 is fixedly connected with the platen base 21. The platen base 21 is movably connected with the movable platen assembly 22, the movable connection mode can be selected as an electromagnetic adsorption connection, and the electrifying electromagnetic induction coil is arranged in the platen base 21. A joint socket is arranged on the platen base 21 and the side, close to the to-be-welded workpiece, of each movable platen, one movable platen is electromagnetically adsorbed in one joint socket, and activity can be realized in the joint socket.

In particular, the electromagnetic adsorption manner of the movable platen assembly 22 is further affected by the material of the movable platen, and the manufacturing material of the optional movable platen is magnetic metal.

With regard to the joint socket in this embodiment, the following two further embodiments may be provided.

In an embodiment, the joint socket is a cylindrical concave cavity, and is arranged on one side of each platen base 21 away from the pressurizing rod 13 and one side of each movable platen close to the next-stage movable platen, each movable platen is matched with the cylindrical surface concave cavity and moves in the cylindrical surface concave cavity under the action of external force, and the number of the movable platens in each stage is gradually increased in the direction from the platen base 21 to the curved-surface workpiece.

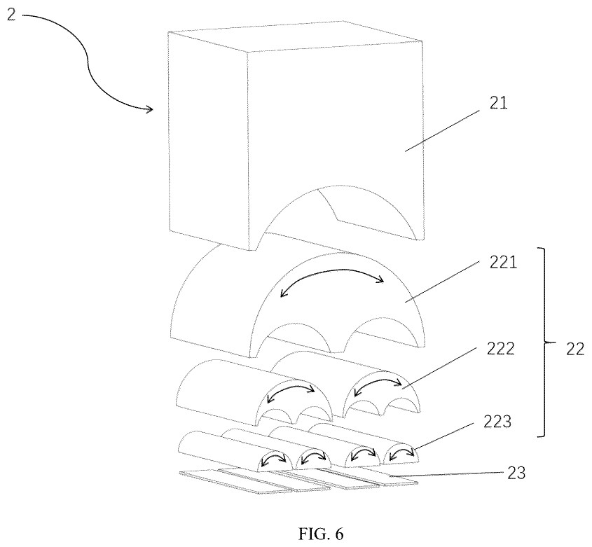

Demonstration Example 2: Referring to FIG. 6, the joint socket in the embodiment is a cylindrical concave cavity, which is respectively arranged on the platen base 21, the first-stage platen 221, the second-stage platen 222 and the third-stage platen 223, and the number of the first-stage platen 221, the second-stage platen 222 and the third-stage platen 223 is increased step by step (for example, the first-stage platen 221 is one, the second-stage platen 222 is two, and the third-stage platen 223 is four), so that the overall activity degree of freedom of the movable platen assembly 22 is increased, and the third-stage platen 223 (or the final-stage platen) may no longer be provided with a joint socket to form an end with a smaller width, thereby increasing the fitting degree with the curved-surface of the to-be-welded workpiece.

It can be understood that, in an embodiment where the joint socket is a cylindrical surface concave cavity, the movement change of the platen is limited in a two-dimensional plane, that is, a plane formed in the direction shown by the bidirectional arrow in FIG. 5, and the curved-surface condition of the embodiment in the three-dimensional space may be limited.

Further, in an embodiment, the joint socket is a spherical concave cavity, and is arranged on one side of each platen base 21 away from the pressurizing rod 13 and one side of each movable platen close to the next-stage movable platen, each movable platen is matched with the spherical concave cavity and moves in the spherical concave cavity under the action of external force, and the number of the movable platens in each stage is gradually increased in the direction from the platen base 21 to the curved-surface workpiece.

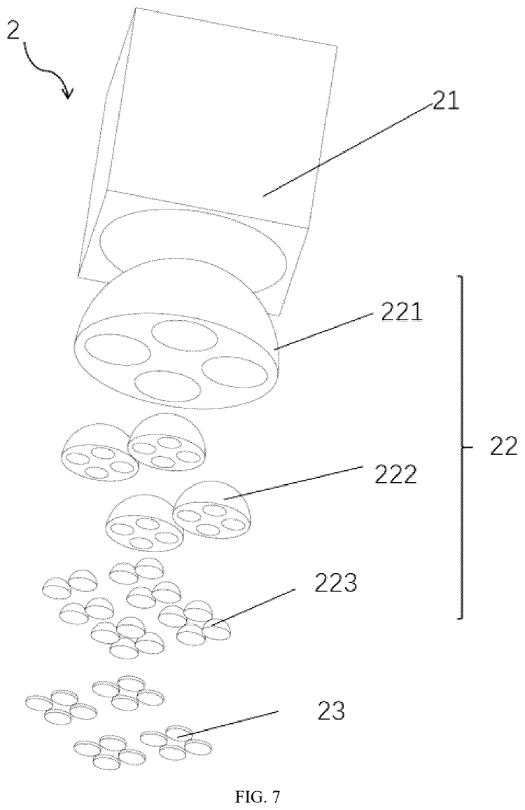

In an embodiment, referring to FIG. 7, the joint socket in this embodiment is a spherical concave cavity, and the arrangement manner thereof may refer to the demonstration example 2. However, in an activity degree of freedom, the spherical concave cavity may enable the movable platen to form activities in countless directions compared with the cylindrical surface concave cavity, in other words, the spherical concave cavity may better fit an irregular curved-surface in the three-dimensional space, and the fitting degree between the spherical concave cavity and the curved-surface may be significantly improved.

In particular, the embodiments are presented by way of illustration only and are not presented as defining relevant specific features. For example, the movable platen assembly 22 may include three or more stages, which may correspondingly adjust the number of stages of the movable platen according to the bending curvature of the workpiece, and when the bending degree of the surface of the workpiece is small, the number of stages of the movable platen can be reduced, and when the bending degree of the surface of the workpiece is large, the number of platen stages is increased to meet the fitting of the high-curvature surface.

In an embodiment, the movable platen assembly 22 in the foregoing embodiment and the movable platen in contact with the curved-surface workpiece are provided with the solder mask plate 23, and the solder mask plate 23 may be made of various materials capable of preventing diffusion welding including high-strength graphite. The function is to avoid molecular diffusion of the movable platen and the curved-surface to form welding.

With the above explanation, this embodiment increases the curved-surface contact member 2 disposed at the end of the pressurizing rod 13, and further forms a better curvature fit between the end platen and the curved-surface (including the irregular complex curved-surface) in the form of the joint socket and the electromagnetic adsorption manner, thereby effectively increasing the effective stress on the curved-surface of the pressurizing rod 13, forming a good stress distribution, and facilitating the forming effect of diffusion welding.

On the basis of the foregoing embodiments, the pressurizing assembly further includes an induction heating member, and the induction heating member is disposed close to the free end of each pressurizing rod 13 to heat the curved-surface of the curved-surface workpiece.

In an embodiment, the induction heating element may be implemented by the electromagnetic induction coil (disposed inside the platen base 21 and not shown in the figure) in the foregoing embodiment, and is electrically connected to the pressurizing system through the wiring channel in each pressurizing rod 13, and the voltage and current in the electromagnetic induction coil are controlled by the pressurizing system, and by adjusting the voltage and current in the electromagnetic induction coil and selecting coil materials with different resistivity, the induction heating effect is formed.

In this embodiment, the induction heating piece is arranged at the end of each pressurizing rod 13 to form a special heating area corresponding to the dot matrix and to-be-welded workpiece curved-surface, and each induction heating piece can also be independently controlled, so that the local heating temperature adjustment has higher synergistic efficiency; and when the even heating condition cannot reach the thermal stress of the curved-surface (including the irregular complex curved-surface), the induction heating piece can be started, and the local heating temperature adjustment is carried out according to the data input of the pressurization system.

It should be noted that the control principle or logic of controlling the dot-matrix pressurizing member 1 and the sensing heating member as a control principle or logic according to the pressurizing system mentioned in the foregoing embodiments is only used for explanation, is not limited as a specific technical feature, and does not belong to the main application point of the present application; and on the other hand, signal control of the pressurizing system belongs to the related art, and details are not described herein again.

In particular, the pressurizing assembly in any one of the preceding embodiments may be used in the same device as a group, paired, and a plurality of on-demand co-cooperation, without the limitation of use alone.

The present application further provides a curved-surface workpiece diffusion welding device, the curved-surface diffusion welding device includes a pressurization system, and an output of the pressurization system is connected to the pressurization assembly in any one of the foregoing embodiments to drive the pressurization assembly to pressurize a to-be-welded workpiece.

In an embodiment, the curved-surface workpiece diffusion welding device includes a pressurization system, a heating system, a vacuum system, and a control system as shown in FIG. 2, the control system is configured to integrate and control the pressurization system, the heating system, and the vacuum system, and the control system includes a control platform that directly faces an operator and receives an operator data output and a control operation.

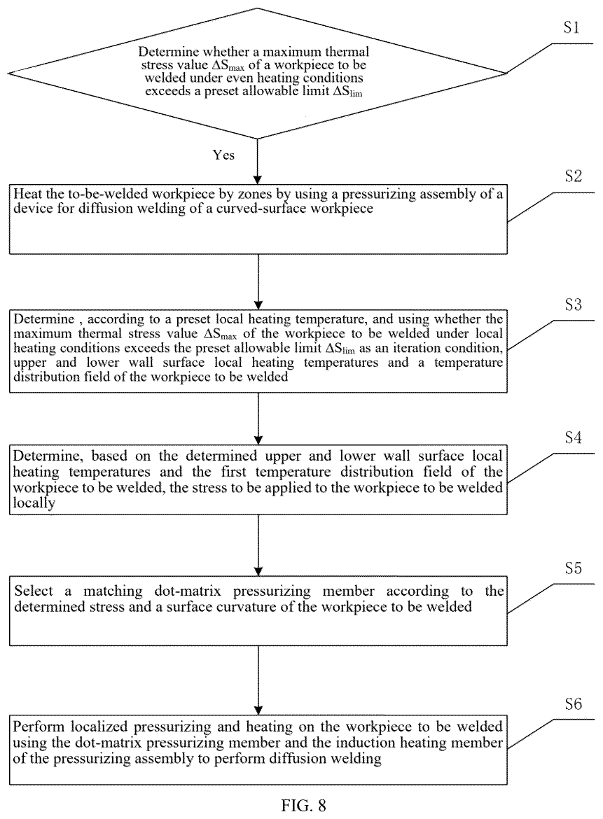

The present application further provides a curved-surface workpiece diffusion welding method, the curved-surface workpiece diffusion welding method is applied to a curved-surface workpiece diffusion welding device, the curved-surface workpiece diffusion welding device includes a pressurizing system, the output of the pressurizing system is connected to a pressurizing assembly as in any one of the previous embodiments to drive the pressurizing assembly to pressurize a workpiece to be welded, and referring to FIG. 8, the method includes the following step S1.

In S1, it is determined whether the maximum thermal stress ΔSₘₐₓ of the workpiece to be welded under an even heating condition exceeds a preset allowable limit ΔSₗᵢₘ.

The even heating condition includes a conventional side wall surface heating manner and an upper and lower wall surface even heating manner performed by using the induction heating member of the pressurizing assembly in the foregoing embodiment, and the same current is generated and radiated by introducing the same current into the electromagnetic induction coil arranged at the end of each pressurizing rod. The maximum thermal stress value ΔSₘₐₓ obtains the temperature field distribution on the to-be-welded workpiece through the temperature monitoring device, such as the infrared sensing device, and then is implemented in a mathematical calculation or experimental determination manner, and by the same reasoning, the preset allowable limit ΔSₗᵢₘ may determine, by means of experiments or theoretical analysis and calculation, an allowable limit value that can meet the lowest-pressure welding condition.

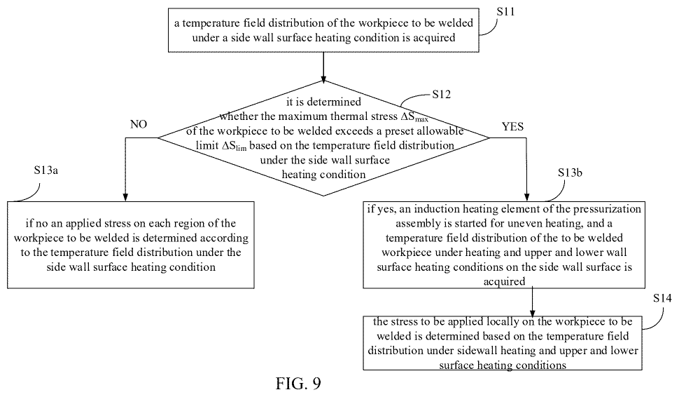

In an embodiment, as shown in FIG. 9, step S1 includes the following steps S11 to S14.

In S11, a temperature field distribution of the workpiece to be welded under a side wall surface heating condition is acquired.

In S12, it is determined whether the maximum thermal stress ΔSₘₐₓ of the workpiece to be welded exceeds a preset allowable limit ΔSₗᵢₘ based on the temperature field distribution under the side wall surface heating condition.

In S13a, if no an applied stress on each region of the workpiece to be welded is determined according to the temperature field distribution under the side wall surface heating condition.

In S13b, if yes, an induction heating element of the pressurization assembly is started for uneven heating, and a temperature field distribution of the to be welded workpiece under heating and upper and lower wall surface heating conditions on the side wall surface is acquired.

In S14, the stress to be applied locally on the workpiece to be welded is determined based on the temperature field distribution under sidewall heating and upper and lower surface heating conditions.

It should be noted that, in the determination process of step S1, regardless of which heating condition, the application stress of each area of the workpiece to be welded is determined according to the temperature field distribution or the side wall surface heating under the heating condition of the side wall surface and the temperature field distribution under the heating condition of the upper wall surface and the lower wall surface, that is, the following steps S5 and S6 can be directly performed for pressure welding.

In the specific implementation of step S1, the temperature field distribution is the temperature data set at each position on the to-be-welded workpiece obtained by the temperature monitoring device in the foregoing explanation description, including a specific temperature value and other alternative numerical values that can represent the temperature value. Determining, according to the temperature field distribution (the temperature data set at each position on the workpiece to be welded), the application stress of each region of the workpiece to be welded through the formula (5).

$${Q}_{local} = {C}_{0} exp ( - E / {RT}_{local} ) {σ}_{local}^{n} \qquad ( 5 )$$

Q_{local} represents the local diffusion welding strength of the workpiece, T_{local} represents the local temperature of the workpiece, σ_{local} represents the local stress value of the workpiece, C₀ represents the normalization coefficient, is a constant, ‘n’ is a normalization index, E represents a volume diffusion activation energy, a constant related to the material type, and R represents a gas constant.

It can be learned from this model that there is a coupling relationship between the workpiece local temperature T_{local} and the workpiece local stress value σ_{local}, and the coupling relationship may be obtained by fitting experimental data, so as to obtain a specific function relationship of the model according to formula (5).

When the even heating condition cannot meet the preset condition, it is indicated that due to the fact that the curved-surface change of the to-be-welded workpiece is large, the structure is complex, the even heating condition cannot enable the thermal stress value of each position of the to-be-welded workpiece to reach the lowest requirement of pressure welding, and therefore, after the step S1, the method further includes the following steps S2 to S6.

In S2, if yes, heating is performed according to a preset local heating temperature. Whether the maximum thermal stress value ΔSₘₐₓ of the workpiece to be welded under local heating conditions exceeds the preset allowable limit ΔSₗᵢₘ is used as the iteration condition to determine upper and lower wall surface local heating temperatures and a temperature distribution field of the workpiece to be welded.

In S4, based on the determined upper and lower wall surface local heating temperatures and the first temperature distribution field of the workpiece to be welded, the stress to be applied to the workpiece to be welded locally is determined.

Similarly, it is determined that the required stress locally applied on the workpiece to be welded is also implemented by the model of formula (5).

Steps S2 to S5 are specific execution steps for performing local heating by using the pressurizing assembly in the foregoing embodiments of the present application, which mainly depends on the “dot-matrix” setting of the induction heating element on each pressurizing rod and forms independent control to realize local heating, and the heating mode can improve the heating efficiency and effect for each region of the curved-surface (including the irregular complex curved-surface), and help the regions of the workpiece to be welded meet the thermal stress requirements required for pressure welding.

In S5, based on the determined required applied stress and the surface profile of the workpiece to be welded, a movable platen assembly is selected and installed.

The selecting and installing the movable platen assembly is mainly used for adaptively adjusting the to-be-welded workpiece according to the actual pressure welding, and the specific manner and effect have been described in the foregoing implementations, and details are not described herein again.

In S6, the workpiece to be welded is subjected to localized independent pressurization and heating through the dot-matrix pressurizing member and induction heating element of the pressurizing assembly to perform diffusion welding.

In the above embodiment, after step S1, the method further includes: if not, directly pressurizing and heating the workpiece to be welded locally by directly passing through the dot-matrix pressurizing member and the induction heating member of the pressurizing assembly, so as to perform pressure welding.

The method provided in the present application relies on the pressurizing assembly described in the foregoing embodiments to achieve coordinated heating and pressurization during the diffusion welding process, thereby improving both the efficiency and effectiveness of welding curved (including irregular and complex curved) surfaces.

The above detailed description of the specific embodiments of the present application is provided by way of example only and should not be construed as limiting the scope of the present application. It will be understood by those skilled in the art that equivalent modifications or substitutions made to the present application all fall within the scope of the present disclosure. Therefore, all equivalent changes, modifications, or improvements made without departing from the spirit and scope of the present application shall be encompassed within the protection scope of the present application.

What is claimed is:

1. A pressurizing assembly for diffusion welding of a curved-surface workpiece, connected to a pressurizing system to apply pressure to the curved-surface workpiece, wherein the pressurizing assembly comprises:
a dot-matrix pressurizing member comprising a driving base and a plurality of pressurizing rods, the driving base being provided with a plurality of mounting positions arranged in a dot-matrix pattern, with each pressurizing rod mounted at its respective mounting position and all the pressurizing rods being parallel to each other, and the driving base being configured to independently drive the plurality of pressurizing rods so as to apply localized and independent pressure to the curved-surface workpiece.

2. The pressurizing assembly according to claim 1, further comprising:
an induction heating element disposed adjacent to a free end of each pressurizing rod to heat respective surface regions of the curved-surface workpiece.

3. The pressurizing assembly according to claim 2, further comprising:
a curved-surface contact member, wherein the curved-surface contact member comprises a platen base fixedly connected to the free end of each pressurizing rod, and a multi-level movable platen assembly disposed at the end of each platen base opposite the pressurizing rod, the movable platen assembly comprising a plurality of stacked movable platens, each platen base is movably connected to the adjacent movable platen and adjacent movable platens are movably connected to one another via electromagnetic attraction and cooperating socket joints.

4. The pressurizing assembly according to claim 3, wherein each socket joint is a cylindrical concave cavity formed on the side of the platen base opposite the pressurizing rod and on the side of each movable platen facing the next lower-level movable platen, and each movable platen is engaged with a respective cylindrical concave cavity and configured to move therein under external force, the number of movable platens increases progressively in the direction from the platen base to the curved-surface workpiece.

5. The pressurizing assembly according to claim 3, wherein the socket joint is a spherical concave cavity, positioned on a side of the platen base that is remote from the pressurizing rod and on a side of the movable platen that is adjacent to a next movable platen, the movable platen is engaged with the spherical concave cavity and moves within the spherical concave cavity under external force, and the number of movable platens increases progressively from the platen base toward the curved-surface workpiece.

6. The pressurizing assembly according to claim 4, wherein a solder mask plate is provided on the movable platen of the movable platen assembly that contacts the curved-surface workpiece.

7. The pressurizing assembly according to claim 3, wherein the driving base is configured to drive each pressurizing rod by means of hydraulic pressure, pneumatic pressure, or mechanical actuation.

8. The pressurizing assembly according to claim 1, wherein an array profile of the mounting positions is a regular polygon.

9. A device for diffusion welding of a curved-surface workpiece, comprising:
a pressurizing system with an output end connected to the pressurizing assembly according to claim 1 to drive the pressurizing assembly to apply pressure to a workpiece to be welded.

10. A method for diffusion welding of a curved-surface workpiece, applied to a device for diffusion welding of a curved-surface workpiece, wherein the device comprises a pressurizing system and the pressurizing assembly according to claim 1, an output of the pressurizing system being connected to the pressurizing assembly, and the method comprises:
determining whether a maximum thermal stress value ΔSₘₐₓ of a workpiece to be welded under even heating conditions exceeds a preset allowable limit ΔSₗᵢₘ;
performing heating, if ΔSₘₐₓ exceeds ΔSₗᵢₘ, according to a preset local heating temperature, and using whether the maximum thermal stress value ΔSₘₐₓ of the workpiece to be welded under local heating conditions exceeds the preset allowable limit ΔSₗᵢₘ as an iteration condition to determine upper and lower wall surface local heating temperatures and a temperature distribution field of the workpiece to be welded;
determining, based on the determined upper and lower wall surface local heating temperatures and the first temperature distribution field of the workpiece to be welded, the stress to be applied to the workpiece to be welded locally;
selecting a matching dot-matrix pressurizing member according to the determined stress and a surface curvature of the workpiece to be welded; and
performing localized pressurizing and heating on the workpiece to be welded using the dot-matrix pressurizing member and the induction heating member of the pressurizing assembly to perform diffusion welding.

11. The method according to claim 10, wherein in the determining whether a maximum thermal stress value ΔSₘₐₓ of a workpiece to be welded under uneven heating conditions exceeds a preset allowable limit ΔSₗᵢₘ, the even heating conditions comprises: evenly heating the side wall surfaces of the workpiece to be welded and evenly heating the upper and lower wall surfaces of the workpiece to be welded.

12. The method according to claim 10, wherein in the determining, based on the determined upper and lower wall surface local heating temperatures and the first temperature distribution field of the workpiece to be welded, the stress to be applied to the workpiece to be welded locally, the stress to be applied to the workpiece to be welded locally is determined from
$${Q}_{local} = {C}_{0} exp ( - E / {RT}_{local} ) {σ}_{local}^{n} ,$$
where Q_{local} represents a local diffusion welding strength of the workpiece, T_{local} represents a local temperature of the workpiece, σ_{local} represents a local stress of the workpiece, C₀ is a normalization coefficient and a constant, n is a normalization exponent, E represents volume diffusion activation energy and is a material-related constant, and R is the gas constant.
